(19) United States
(12) Patent Application Publication
(10) Pub. No.: US 2005/0210408 A1
(43) Pub. Date: Sep. 22, 2005

(54) Alternative, customizable, simplified device settings menu

(76) Inventor: Emilia D. Baranda, Concord, CA (US)

Correspondence Address: Kyocera Technology Development;Intellectual Property administration, Suite 400, 1855 Gateway Blvd., Concord, CA, 94520, US

(21) Appl. No.: 10/805,469

(22) Filed: Mar. 19, 2004

(51) Int. Cl. G06F 3/00; G06F 17/24

(52) U.S. Cl. 715/810; 715/527; 715/777

(57) ABSTRACT

A method for providing a smaller, simplified menu for a device, by providing a GUI for switching between the simplified menu and a regular menu after installing a driver. The simplified menu comprises a predefined set of device settings in a single light tab. This factory-default, predefined set is a commonly-used subset of parameters for a printer or another device. Arranging common settings in this manner avoids having to go to different pages in the menu by clicking on tabs. Methods include multiple simplified menu tabs, additional tabs that may have duplicate settings, GUI for customizing the simplified menu, which may allow specifying the default value for a setting, customizing from a list or from a regular tab, visually differentiating a duplicated setting, and visually differentiating a moved setting.

### CROSS-REFERENCES TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention relates to the field of graphical user interfaces (GUI), and more particularly to providing an alternative, customizable, and simplified menu for a device.

### BACKGROUND OF THE INVENTION

Device drivers are generally known, including a printer driver. Typically, printing from a computer occurs through the use of a printer driver. Upon either an application launch or during a print command load time, the application will call an instance of the printer driver and provide the user with an interface to set the desired printer driver settings. Printer driver settings may also be called printer options, print settings, driver options, printer parameters, print selections, etc. The printer driver settings specify preferences on features of the printer.

In a typical GUI (Graphical User Interface) for a device settings menu, the various settings and selections are organizing into several pages, each of which is accessible by clicking on the respective tabs. The various settings are displayed within each page corresponding to the tab. As the number of adjustable features increases, it becomes more difficult to locate the desired setting. Furthermore, having to move to different pages by clicking on the tabs is cumbersome.

The present invention arose out of the above concerns associated with providing an improved, alternative, customizable, and simplified menu for a device.

### SUMMARY OF THE INVENTION

Methods, computer program products, computing and printing systems for providing a smaller, simplified menu for a device, by providing a GUI for switching between the simplified menu and a regular menu after installing a driver are described.

The simplified menu comprises a predefined set of device settings in a single light tab. This factory-default, predefined set is a commonly-used subset of parameters for a printer or another device. Arranging common settings in this manner avoids having to go to different pages in the menu by clicking on tabs.

Methods include multiple simplified menu tabs, additional tabs that may have duplicate settings, GUI for customizing the simplified menu, which may allow specifying the default value for a setting, customizing from a list or from a regular tab, visually differentiating a duplicated setting, and visually differentiating a moved setting.

The invention will be more fully understood upon consideration of the detailed description below, taken together with the accompanying drawings.

### DESCRIPTION OF THE DRAWINGS

FIG. 1 is a simplified block diagram showing connection of a computing system to a printer.

FIG. 2 is a view of the GUI (Graphical User Interface) for a prior art device driver menu with multiple tabs.

FIG. 3 is a view of the GUI for providing a simplified, predefined menu for a device driver in a single tab, in accordance with a preferred embodiment of the present invention.

FIG. 4 is a flowchart showing selection between a simplified menu and a regular menu, in accordance with a preferred embodiment of the present invention.

FIG. 5 is a flowchart showing how a user can freely switch between a simplified menu and a regular menu after installing a device driver, in accordance with a preferred embodiment of the present invention.

FIG. 6 is a block diagram showing how the set of settings in the simplified menu is a subset of the available settings for the device driver, in accordance with a preferred embodiment of the present invention.

FIG. 7 is a flowchart showing how a user can customize the simplified menu by adding a setting to the simplified menu, in accordance with a preferred embodiment of the present invention.

FIG. 8 is a flowchart showing how a user can customize the simplified menu by selecting a setting item to add from a list of available settings for a device, in accordance with a preferred embodiment of the present invention.

FIG. 9 is a flowchart showing how a user can customize the simplified menu by selecting a setting item to add from a regular tab, in accordance with a preferred embodiment of the present invention.

FIG. 10 is a view of the GUI containing multiple simplified tabs and additional regular tabs, in accordance with a preferred embodiment of the present invention.

FIG. 11 is a block diagram showing absence and presence of a duplicate setting that is shared by a simplified tab and another tab, as well as a method of differentiating such an item in a first visually distinct manner, in accordance with a preferred embodiment of the present invention.

FIG. 12 is a block diagram showing a method of differentiating a setting item in a regular tab that is deactivated by having been moved to a light tab in a second visually distinct manner, in accordance with a preferred embodiment of the present invention.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

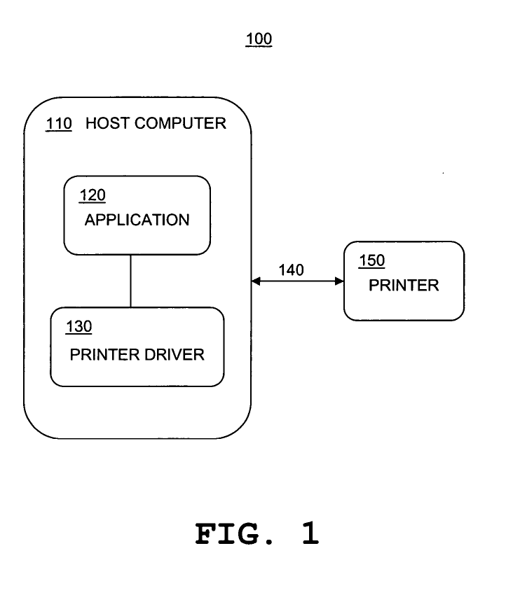

FIG. 1 shows a general printing system setup 100 that includes a host computer 110 and a printer 150. Here, the printer 150 may be any device that can act as a printer, e.g. an inkjet printer, a laser printer, a photo printer, or an MFP (Multifunction Peripheral or Multi-Functional Peripheral) that may incorporate additional functions such as faxing, facsimile transmission, scanning, and copying.

The host computer 110 includes an application 120 and a printer driver 130. The application 120 refers to any computer program that is capable of issuing any type of request, either directly or indirectly, to print information. Examples of an application include, but are not limited to, commonly used programs such as word processors, spreadsheets, browsers and imaging programs. Since the invention is not platform or machine specific, other examples of application 120 include any program written for any device, including personal computers, network appliance, handheld computer, personal digital assistant, handheld or multimedia devices that is capable of printing.

The printer driver 130 is a software interfacing with the application 120 and the printer 150. Printer drivers are generally known. They enable a processor, such as a personal computer, to configure an output data from an application that will be recognized and acted upon by a connected printer. The output data stream implements necessary synchronizing actions required to enable interaction between the processor and the connected printer. For a processor, such as a personal computer, to operate correctly, it requires an operating system such as DOS (Disk Operating System) Windows, Unix, Linux, Palm OS, or Apple OS.

A printer I/O (Input/Output) interface connection 140 is provided and permits host computer 110 to communicate with a printer 150. Printer 150 is configured to receive print commands from the host computer and, responsive thereto, render a printed media. Various exemplary printers include laser printers that are sold by the assignee of this invention. The connection 140 from the host computer 110 to the printer 150 may be a traditional printer cable through a parallel interface connection or any other method of connecting a computer to a printer used in the art, e.g., a serial interface connection, a remote network connection, a wireless connection, or an infrared connection. The varieties of processors, printing systems, and connection between them are well known.

The present invention is suited for printer driver settings, and it is also suited for other device drivers. The above explanations regarding FIG. 1 used a printer driver rather than a general device driver for concreteness of the explanations, but they also apply to other device drivers. Similarly, the following descriptions of the preferred embodiments generally use examples pertaining to printer driver settings, but they are to be understood as similarly applicable to other kinds of device drivers.

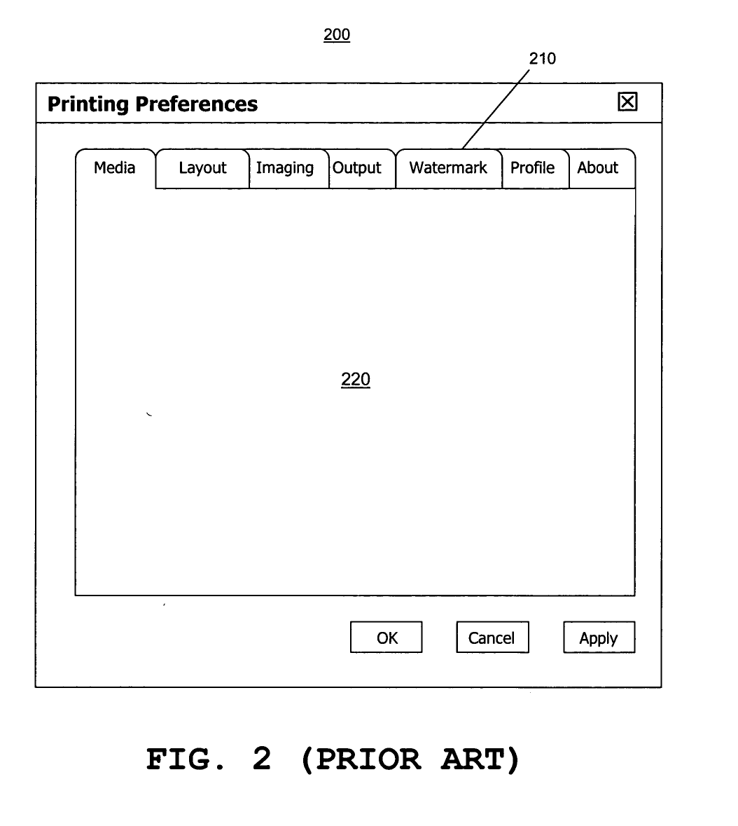

FIG. 2 is a view of the GUI (Graphical User Interface) for a prior art menu for a device. The user typically accesses this menu 200 by clicking on the “Properties” button in the print menu. Here, the various settings and selections are organizing into several pages, each of which is accessible by clicking on the respective tabs 210. The various settings 220 (not shown) are displayed within each page corresponding to the tab 210. As the number of adjustable features increases, it becomes more difficult to locate the desired setting. Furthermore, having to move to different pages by clicking on the tabs 210 is cumbersome.

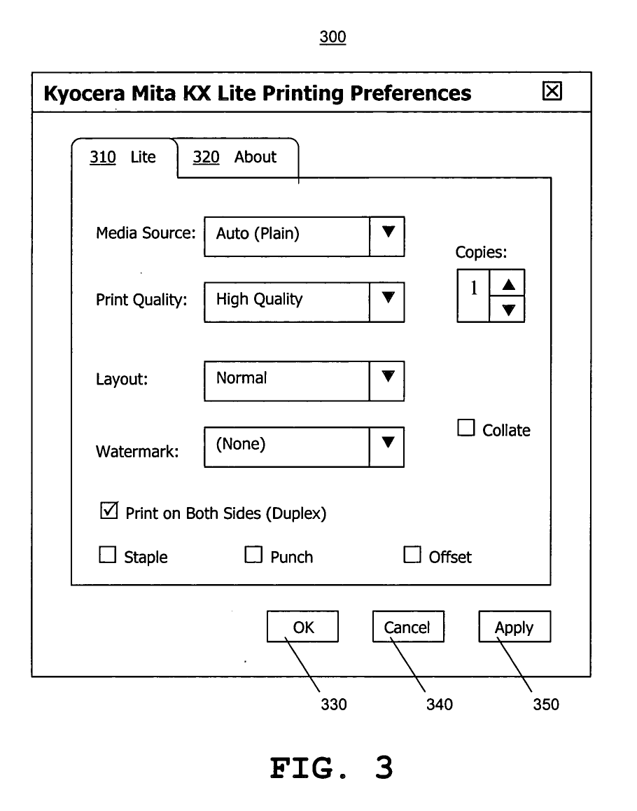

FIG. 3 is a view of the GUI for providing a simplified, predefined menu for a device driver in a single tab, in accordance with a preferred embodiment of the present invention. The menu 300 consists basically of one main page, with a corresponding tab 310. The main tab for a simplified menu is called a “light tab” or a “simplified tab” and it is also shown in the figures as a “Lite” tab. There is an additional “About” tab 320 for the page displaying the version information, copyright notice, etc. Conventional tabs of the prior art menu 200 are called “regular tabs”. The regular tabs include the About tab.

The typical simplified menu shown 300 contains the settings for media source, print quality, copies, layout, watermark, duplex, staple, punch, and offset. This particular set of settings shown in the typical simplified menu 300 is only an example. By gathering these commonly used settings in one page, the user need not move to different pages to locate the particular settings. This collection of settings is a basic, factory-default subset of all the available settings for the device. These default set of settings can be customized using the methods described below.

The typical simplified menu shown 300 also contains the buttons “OK” 330, “Cancel” 340, and “Apply” 350 in the lower portion. Clicking on OK 330 causes control to return to the previous position, typically the print menu, after applying the setting changes. Clicking on Cancel 340 causes control to return to the previous position, typically the print menu, without applying the setting changes. Clicking on Apply 350 causes control to remain in the current Printing Preferences, after applying the setting changes. The GUI and methods for switching between the simplified menu 300 and the regular menu 200 will be described below.

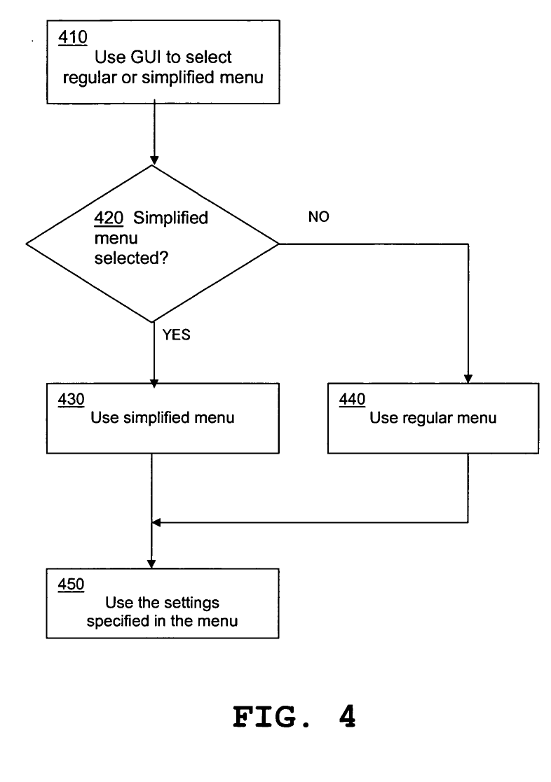

FIG. 4 is a flowchart showing selection between a simplified menu and a regular menu, in accordance with a preferred embodiment of the present invention. First, in step 410 the user uses the GUI to select between the simplified menu 300 and the regular menu 200. The GUI may employ any of the methods generally known, including checkboxes, buttons, radio buttons, list boxes, combo boxes, scroll bars, push buttons, group boxes, pulldown menus 3-state buttons, trees with selectable items, etc. Then in step 420, determination is made to see if the simplified menu is selected. If the simplified menu is selected, the simplified menu 300 is displayed and used in step 430. Otherwise, the regular menu 200 is displayed and used in step 440. In either case, after the user has made setting changes and indicated that the changes be applied, the specified settings are used in step 450.

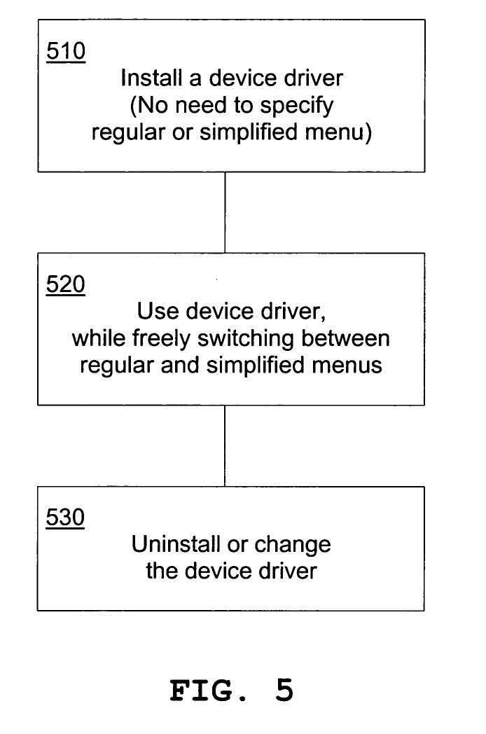

FIG. 5 is a flowchart showing how a user can freely switch between a simplified menu and a regular menu after installing a device driver, in accordance with a preferred embodiment of the present invention. First, in step 510 the user installs a device driver. This is typically done when the user first acquires a device, such as a printer, or when the user upgrades the device. At the time of the device driver installation, the user needs not specify whether to use the regular menu or the simplified menu. In step 520, the user can use the device driver, while freely switching between the regular menu and the simplified menu, using the method described in FIG. 4. There is no need to uninstall or reinstall the device driver in order to change the menu to be used. Then in step 530, the user may uninstall or change (reinstall) the device driver if the user needs to or desires to do so.

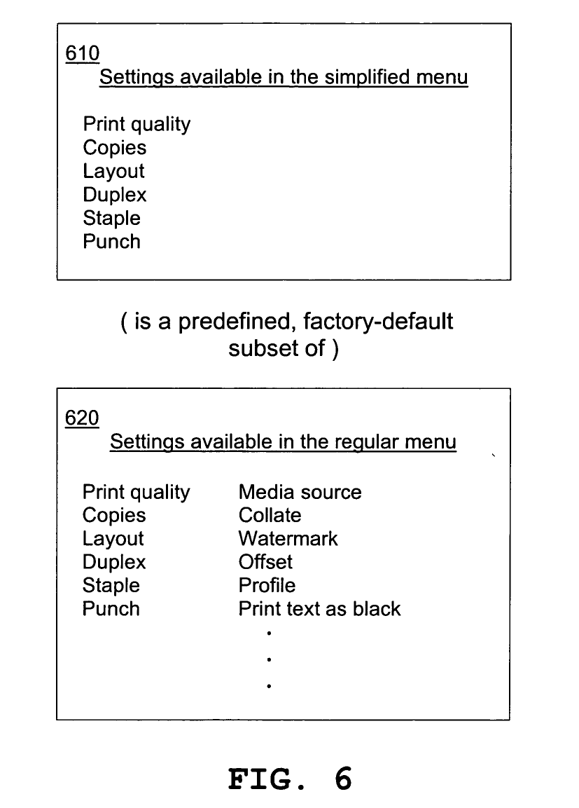

FIG. 6 is a block diagram showing how the set of settings in the simplified menu is a subset of the available settings for the device driver, in accordance with a preferred embodiment of the present invention. Here, the settings available in a sample simplified menu 610 include print quality, copies, layout, duplex, staple, and punch. This set of settings 610 in the simplified menu is a predefined, factory-default subset of the all the settings available in the regular menu 620, which additionally includes media source, collate, watermark, offset, profile, print text as black, etc.

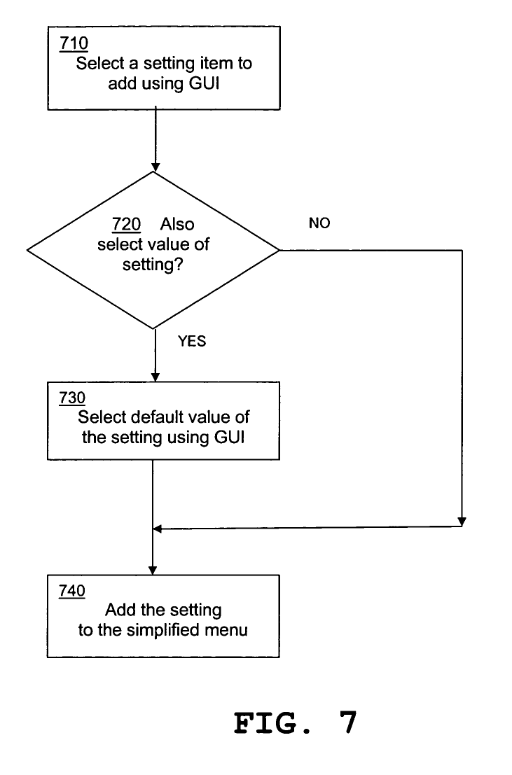

FIG. 7 is a flowchart showing how a user can customize the simplified menu by adding a setting to the simplified menu, in accordance with a preferred embodiment of the present invention. First, in step 710, the user selects a setting item to add using GUI. Then in step 720, determination is made to see if the user intends to select a default value of the setting item. If so, the user specifies the default value of the setting item using GUI in step 730. Next in step 740, the setting item is added to the simplified menu. Removal of a setting from the simplified menu is a reverse of this process.

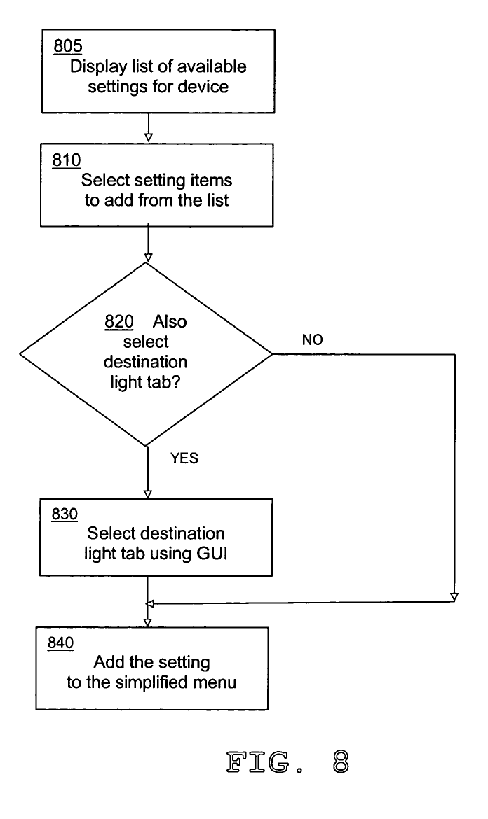

FIG. 8 is a flowchart showing how a user can customize the simplified menu by selecting a setting item to add from a list of available settings for a device, in accordance with a preferred embodiment of the present invention. First, in step 805, the list of all available settings for a device is displayed. The GUI for displaying the list of all available settings for the device may be a part of the regular menu, a part of the simplified menu, a part of a separate menu, a part of a separate device installer, etc. Then in step 810 the user selects the setting items to add to the simplified menu from the list. The GUI for selecting from this list may employ any of the methods generally known, including checkboxes, buttons, radio buttons, list boxes, combo boxes, scroll bars, push buttons, group boxes, pulldown menus 3-state buttons, trees with selectable items, etc. Then in step 820, a determination is made whether to select a destination light tab to which the selected items are to be added. This is applicable only when there are two or more light tabs in the simplified menu. If the user chooses to select the destination tab, this is performed in step 830. Then, finally in step 840, the item is added to the simplified menu. Removal of a setting from the simplified menu is a reverse of this process.

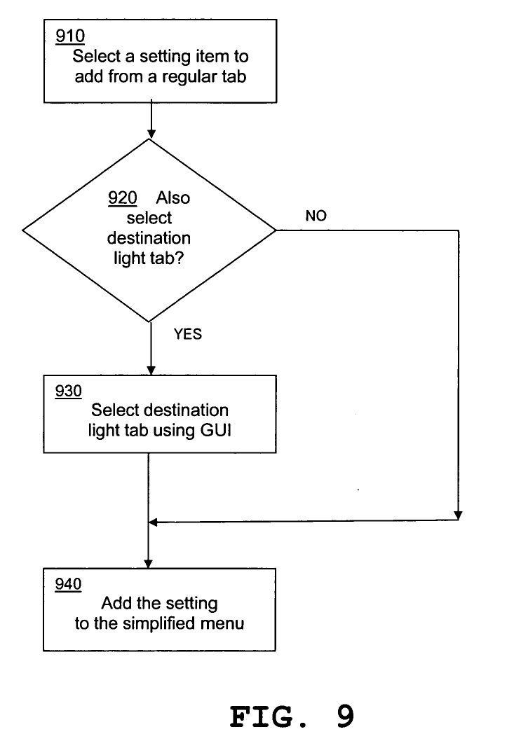

FIG. 9 is a flowchart showing how a user can customize the simplified menu by selecting a setting item to add from a regular tab, in accordance with a preferred embodiment of the present invention. First, in step 910, a setting item to be added is selected from a regular tab. The selecting of the setting item to add and indicating its addition to the simplified menu may employ any of the methods generally known, including right-clicking on the mouse followed by choosing “Add to simplified menu” from the displayed menu, drag-and-drop to a region designated for “Add to simplified menu”, etc. Then, in step 920, a determination is made whether to select a destination light tab to which the selected items are to be added. This is applicable only when there are two or more light tabs in the simplified menu. If the user chooses to select the destination tab, this is performed in step 930. Then, finally in step 940, the item is added to the simplified menu. Removal of a setting from the simplified menu is a reverse of this process.

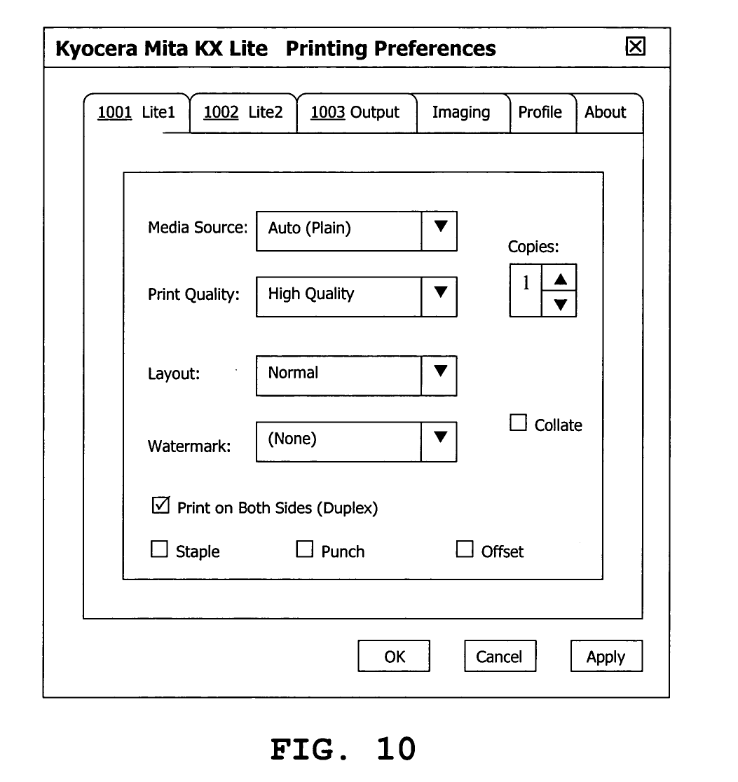

FIG. 10 is a view of the GUI containing multiple simplified tabs and additional regular tabs, in accordance with a preferred embodiment of the present invention. In a preferred embodiment of the present invention, the simplified menu comprises a plurality of light tabs. In FIG. 10, the light tabs are named “Lite1” 1001 and “Lite2” 1002. The simplified menu may also comprise additional regular tabs 1003.

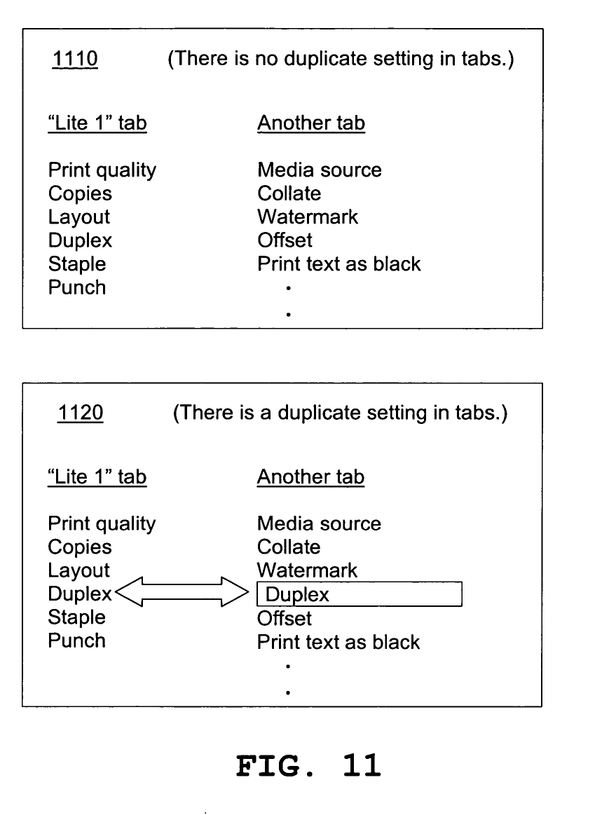

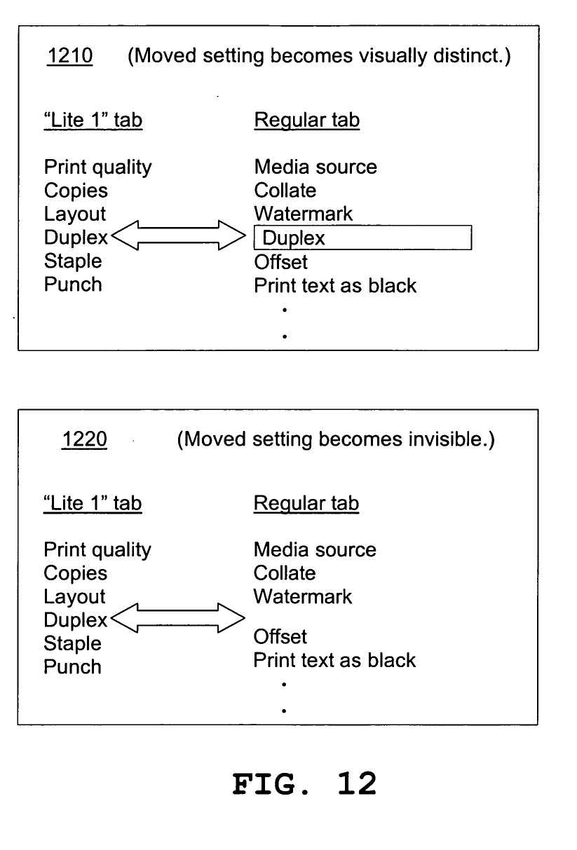

FIG. 11 is a block diagram showing absence and presence of a duplicate setting that is shared by a simplified tab and another tab, as well as a method of differentiating such an item in a first visually distinct manner, in accordance with a preferred embodiment of the present invention. There may no duplicate setting in tabs 1110. This would be the case if a setting item that is included in a light tab is not allowed to be in another tab within the menu, as in FIG. 12. There may be a duplicate setting item in a light tab and another tab 1120. Here, the Duplex setting item is duplicated in the “Lite 1” tab and another tab. Note that a Duplex setting item typically comprises a label and a checkbox. According to a preferred embodiment of the present invention, such a duplicated item is differentiated in a first visually distinct manner. FIG. 11 shows the duplicated Duplex item with an enclosing box. In the actual GUI, this may also be an underline, font change, size change, color, blinking, or any combinations thereof, etc.

FIG. 12 is a block diagram showing a method of differentiating a setting item in a regular tab that is deactivated by having been moved to a light tab in a second visually distinct manner, in accordance with a preferred embodiment of the present invention. According to a preferred embodiment of the present invention, a setting item in a regular tab that is deactivated by having been moved to a light tab is differentiated in a second visually distinct manner 1210. Here, the Duplex setting item has been moved from a regular tab to the “Lite 1” tab. Note that a Duplex setting item typically comprises a label and a checkbox. According to a preferred embodiment of the present invention, such a moved item is differentiated in a second visually distinct manner. FIG. 12 shows the duplicated Duplex item with an enclosing box. In the actual GUI, this may also be an underline, font change, size change, color, blinking, or any combinations thereof, etc. Depending on the new color chosen, the moved setting item may become invisible 1220.

Although this invention has been largely described using terminology pertaining to printer drivers, one skilled in this art could see how the disclosed methods can be used with other device drivers. The foregoing descriptions used printer drivers rather than general device drivers for concreteness of the explanations, but they also apply to other device drivers. Similarly, the foregoing descriptions of the preferred embodiments generally use examples pertaining to printer driver settings, but they are to be understood as similarly applicable to other kinds of device drivers.

Although this invention has been largely described using Windows terminology, one skilled in this art could see how the disclosed methods can be used with other operating systems, such as DOS, Unix, Linux, Palm OS, or Apple OS, and in a variety of devices, including personal computers, network appliance, handheld computer, personal digital assistant, handheld and multimedia devices, etc. One skilled in this art could also see how the user could be provided with more choices, or how the invention could be automated to make one or more of the steps in the methods of the invention invisible to the end user.

While this invention has been described in conjunction with its specific embodiments, it is evident that many alternatives, modifications and variations will be apparent to those skilled in the art. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

1. A method for providing a simplified menu for a device, comprising providing a GUI for switching between the simplified menu and a regular menu after installing a driver, wherein the simplified menu comprises a predefined set of commonly-used device settings in a single light tab.

2. The method of claim 1, wherein the simplified menu contains at least one setting that is a factory-default subset of available settings for a printing device.

3. The method of claim 1, wherein the simplified menu comprises a plurality of light tabs.

4. The method of claim 1, further comprising a GUI for customizing the simplified menu, wherein the customizing of the simplified menu comprises: selecting a setting item to add; adding the setting item to the simplified menu; and optionally specifying a default value for the setting item.

5. The method of claim 4, wherein the selecting of the setting item to add comprises: displaying a list of available settings for the device; indicating at least one setting item to add; and optionally selecting a destination light tab.

6. The method of claim 4, wherein the selecting of the setting item to add comprises: selecting a setting item to add from a regular tab; and optionally selecting a destination light tab.

7. The method of claim 4, wherein a setting item in a regular tab that is duplicated in a light tab is differentiated in a first visually distinct manner.

8. The method of claim 4, wherein a setting item in a regular tab that is deactivated by having been moved to a light tab is differentiated in a second visually distinct manner.

9. A computer program product for providing a simplified menu for a device, comprising machine-readable code for causing a machine to perform the method step of: providing a GUI for switching between the simplified menu and a regular menu after installing a driver, wherein the simplified menu comprises a predefined set of commonly-used device settings in a single light tab.

10. The computer program product of claim 9, wherein the simplified menu contains at least one setting that is a factory-default subset of available settings for a printing device.

11. The computer program product of claim 9, further comprising machine-readable code for causing a machine to provide a GUI for customizing the simplified menu, wherein the customizing of the simplified menu comprises: selecting a setting item to add; adding the setting item to the simplified menu; and optionally specifying a default value for the setting item.

12. The computer program product of claim 11, wherein the selecting of the setting item to add comprises: displaying a list of available settings for the device; indicating at least one setting item to add; and optionally selecting a destination light tab.

13. The computer program product of claim 11, wherein the selecting of the setting item to add comprises: selecting a setting item to add from a regular tab; and optionally selecting a destination light tab.

14. The computer program product of claim 11, further comprising machine-readable code for causing a machine to provide a GUI for customizing the simplified menu wherein a setting item in a regular tab that is duplicated in a light tab is differentiated in a first visually distinct manner.

15. The computer program product of claim 11, further comprising machine-readable code for causing a machine to provide a GUI for customizing the simplified menu wherein a setting item in a regular tab that is deactivated by having been moved to a light tab is differentiated in a second visually distinct manner.

16. A computing system, comprising a device driver programmed to provide a simplified menu for a device, comprising providing a GUI for switching between the simplified menu and a regular menu after installing the driver, wherein the simplified menu comprises a predefined set of commonly-used device settings in a single light tab.

17. The computing system of claim 16, further comprising a print engine, wherein the simplified menu contains at least one setting that is a factory-default subset of available settings for a printing device.

18. The computing system of claim 16, further comprising a GUI for customizing the simplified menu, wherein the customizing of the simplified menu comprises: selecting a setting item to add; adding the setting item to the simplified menu; and optionally specifying a default value for the setting item.

19. The computing system of claim 18, wherein the selecting of the setting item to add comprises: displaying a list of available settings for the device; indicating at least one setting item to add; and optionally selecting a destination light tab.

20. The computing system of claim 18, wherein the selecting of the setting item to add comprises: selecting a setting item to add from a regular tab; and optionally selecting a destination light tab.

21. The computing system of claim 18, wherein a setting item in a regular tab that is duplicated in a light tab is differentiated in a first visually distinct manner.

22. The computing system of claim 18, wherein a setting item in a regular tab that is deactivated by having been moved to a light tab is differentiated in a second visually distinct manner.
